(19) United States
(12) Patent Application Publication
(10) Pub. No.: US 2020/0038147 A1
(43) Pub. Date: Feb. 6, 2020

(54) DENTAL IMPLANT, CONNECTING SCREW AND KIT FOR IMPLANTATION

(71) Applicant: Nikita Sergeevich CHERNOVOL, Sankt-Peterburg (RU)

(72) Inventor: Nikita Sergeevich CHERNOVOL, Sankt-Peterburg (RU)

(21) Appl. No.: 16/339,533

(22) PCT Filed: Feb. 20, 2018
(86) PCT No.: PCT/RU2018/000097

§ 371 Date: Apr. 4, 2019

(30) Foreign Application Priority Data
Jul. 17, 2017 (RU) 2017125447

(51) Int. Cl. A61C 8/00

(52) U.S. Cl. CPC A61C 8/0068

(57) ABSTRACT

The invention relates to a dental implant for mounting in the jaw bone, comprising a base portion, an abutment and a connecting screw, the post of said connecting screw having a stepped design, wherein the diameter of the bottom part thereof before the beginning of the thread of the post does not exceed the inner diameter of the bearing thread of the abutment, and the distance from the head of the screw to the top end thereof is smaller than the axial distance from the head of the screw to the bearing thread of the abutment by 0.1-1 mm (optimally by 0.2-0.3 mm). According to claim 1, comprising the base portion of the implant, the abutment, and auxiliary components, the latter comprising a set of connecting screws having a screw thread pitch appropriate for the abutment sizes for prosthesis implantation in patients with a high, medium and low gum height.

### CROSS-REFERENCE TO RELATED APPLICATIONS

The present application is the US National stage application from the PCT application PCT/RU2018/000097 filed Feb. 20, 2018, which claims priority to Russian patent application RU2017125447 filed Jul. 17, 2017.

### FIELD OF THE INVENTION

The invention relates to surgical and orthopedic dentistry, in particular to implantology, namely to devices for placement of dental prosthesis in place of a lost tooth, or rather to tooth (dental) implants.

### BACKGROUND OF THE INVENTION

The dental implant is placed either directly into the hole formed after tooth extraction or after its healing (delayed implantation). After the dental implant is placed, its surface must be osteointegrated inside the jaw bone. If after implant placement, its primary stability is insufficient or the patient has such risk factors as diabetes, smoking, etc., it is preferable to place the implant using two-stage method with closed healing, and prosthetics should be performed after osseointegration.

The implant can be one-component or consist of two or more components. In case of delayed implantation, as a rule, two-component implant is used, which helps to close the soft tissues on top of the implant for the time necessary for healing.

Exterior design of most implants resembles a screw. This screw is screwed into maxilla or mandible after preparation of the bone bed for the implant. In most cases, such dental implant consists of the base part of the implant (hereinafter referred to as BP), placed in the bone tissue of the jaw (in dentistry books it is commonly referred to as implant), and the abutment for fixation of prosthodontic components. The implant has a receiving hole for the abutment at its coronal end. The abutment is fixed in the upper part of the BP by means of a threaded connection and a connecting fixing screw (hereinafter CS), which connects the abutment and the base part, as well as presses the abutment to the surface of the base part of the implant.

The structure of dental implants and features of manufacturing of their component elements are described in several hundred patents in different countries (RU 2602678, 2016; RU 2567596, 2014; RU 2485910, 2012; US 2005/0287497, 2005; WO 03020154, 2003. DE 10315399, 2004; EP 1728486, 2006; WO 97/20518, 1997; WO 96/29020, 1996, etc.).

In particular, according to the information they contain, the base part is usually made in the form of an appropriately molded metal body, which consists of intraosseous and extraosseous parts and has a receiving hole at its coronal end, into which the abutment is inserted. (The term “coronal” in this case and in the future will be used for direction that is oriented towards the crown or towards the tooth being placed on it, and cervical refers to the direction oriented to the root of the tooth). At the cervical end, the base part on the outside is threaded to secure the implant in a suitably prepared bed in the jawbone. The thread can be both self-tapping and non-self-tapping. In this case, the design of the thread provided in the outer area of the base part is usually designed in view of high primary stability of the system and in view of uniform transfer of forces arising from the masticatory load on the dental implant, on the jaw bone, but its design does not always helps to solve this problem.

Thus, an implant is known in which the base part has an external thread with a thread pitch of about 0.6 mm (U.S. Pat. No. 5,588,838, 1996). This design does not result in reliable fixation of the implant in the spongy bone and is not able to withstand early masticatory loads, due to the low profile and small pitch of the thread in the base part. Prosthetics using this design can be made only in 3-6 months after its placement, which delays the treatment period.

Carried out with an opportunity of placement in the receiving hole of the base part, the abutment has a surface for direct or indirect placement of orthopedic restoration (for example, a crown) and a connecting area for connection to the implant, which can usually be inserted into the above-mentioned receiving hole of the implant. Connecting zone of the abutment has a conical part of a certain length of the cone with adjacent cervical direction index part with a certain index length.

Making an abutment connecting zone and corresponding mating inner surface of the implant base provides improved mechanical connection of the elements and promotes formation of a hermetic seal between them, which helps to avoid formation of a gap in which liquids or bacteria can accumulate. However, such conical structures have a number of disadvantages. In particular, the subsequent formation of the implant may cause a height displacement due to the presence of tolerances for the angle and diameter of the cone.

Usually on the surface of the abutment there is an index area, which purpose is to provide a reliable rotation and positioning of the abutment and the implant base part during assembly of the implant and at the same time as a surface for approach the capture tool (RU 2273464, 2006; RU 2485910, 2013).

It is important to choose a connection of the base element—abutment, which should be strong enough, because it transfers the load from the orthopedic restoration to the osteointegrated base of the implant. Therefore, it should support the implant structures and prevent fractures or weakening of all individual components of dental implant restorations.

Previously such connections used a connecting pin that protruded over the base part of the implant, and the connecting part on the abutment was designed in such a way, that it can be placed exactly on the connecting pin. Thus, connection of these parts was made by means of the screw. However, the lack of structural strength due to possibility of breakage of the pin and technical difficulties of its replacement required a more advanced solutions.

In modern products, the connecting pins were transferred to the abutments, and the connection zone—inside the base part of the implant. In this case, the connection in these structures is mainly located inside the implant and is conical and there are guides to prevent rotation of the abutment, and the abutment connection surface is tilted towards the inner surface of the implant. The abutment in the cervical direction, adjacent to the index area at the cervical end, has an end surface with a hole in it. Through this hole, the abutment is connected to the base part by means of a specially selected connecting (fixing) screw. In this case, a threaded portion of the fixing screw is inserted through the abutment hole mentioned above, which is then screwed into the corresponding internal thread of the base part. As a result, the screw head presses the abutment to the base part.

The length of the screw and, in particular, the location of the thread on it are selected in such a way that the abutment screw cannot be engaged with the threaded portion in the implant while the abutment of the end surface of its cam on the cervical end is not placed on the implant platform. This prevents an opportunity that the abutment will be incorrectly secured in the implant by tightening the abutment screw before reaching the desired position.

In particular, an implant (RU 2567596, 2015) consisting of a base part, an abutment and a connecting screw is proposed as the closest analogue of the dental implant. At the coronal end of the base part, there is a receiving hole for the abutment, which has a conical section and an index section of a cylindrical shape forming a guide surface for the placed abutment. On the cylindrical section of the base part there is at least one groove made in the radial direction to the outside, and on the cylindrical section of the abutment there is the same number of cams, and the grooves are made with an opportunity of engagement with the corresponding abutment cam and having an outer diameter that is less than or equal to the minimum diameter of the conical section. In the cervical direction of the base element, there is a threaded portion directly adjacent to the index section to place the locking screw.

Common disadvantage of known implants is the lack of consideration of the relationship between the optimal structure of the implant and the gingiva height.

During the dental implant surgery, it is necessary to combine the reliability of the base part—abutment connection and aesthetic requirements to the appearance of the patient's mouth after the implantation. It was determined that the optimal aesthetic perception is achieved when the widest part of the abutment (“shoulders” of the abutment) are located at the level of the gingiva height. In this case, the gingiva should be as narrow as possible.

As you know, the function of the abutment is to pass through the soft tissue of the gingivas and connect the base of the implant with orthodontic components. To do this, when placing standard prosthesis, in particular, the nearest analogue, it is necessary to use an abutment of sufficiently large diameter, because the screw head should be located at the level of the gingiva height and have sufficient space inside the thick part of the abutment. In this case, its diameter should be greater than the diameter of the thread. However, in this case, it is not possible to achieve a solution to the problem of rather narrow aesthetic gingiva.

While keeping a narrow gingiva the screw head will be located inside the narrow part of the abutment, which will require reduction of thickness of the abutment wall resulting in a high risk of rupture of the implant during its use and to solve the problem of such a risk it is necessary to have an additional length of the screw. In this case, there is a problem: the gingiva characteristic is individual for a particular person, in particular, its height can be from 0.5 mm up to 6 mm. At the same time, different gingiva height requires different thread and screw length.

FIG. 1 shows a connection of the implant abutment with a screw inside and short gingiva height (GH). FIG. 2 shows a location of the abutment-implant with a high gingiva height (GH). Analysis of the situation shows that in case of mismatch of the screws, the short screw will not work inside the abutment with high gingiva height (FIG. 3), and the thread of the long screw will be inside the thread of the implant, but will not press the abutment to the BP of implant (FIG. 4), which creates a high risk of failure of the connection when the torque is applied to the screw, resulting in an opportunity that the orthodontic part will be attached to the abutment without fixing the abutment to the implant BP.

### SUMMARY

At the heart of the solution of the problem under consideration is a change in the design of the connecting screw. At present, a screw consisting of a head and a stem with a thread placed on its bottom part is used for connection. In this case the diameter of the stem throughout its length and the thread are approximately the same (Standard screw is shown in FIG. 5.)

Such connecting screw is described, in particular, in the patent (RU 2593349, 2016) with the technical character closest to the claimed solution with regard to the screw, where a connecting fixing screw for a dental implant with a length of 1.6 to 3.2 mm with a head diameter of 1.6 to 2.4 mm is proposed, for connecting the abutment to the intraosseous base part. The screw consists of a head and a stem, which lower part has a thread to attach the screw to the implant BP.

Disadvantage of this screw is a lack of reliability of the connection in case of use of the implant in patients with narrow gingivas of different height.

The technical task in relation to the connecting screw was to modify its design, which provides a reliable abutment-base part connection during surgeries in patients with narrow gingivas of different heights.

Technical result with respect to the connecting screw is achieved by making a narrower screw stem by boring its lower part up to the thread with a diameter not exceeding the inner diameter (core) of the abutment support thread. This design helps the lower part of the threaded stem to pass through the abutment support thread and be fixed both by a stem of the corresponding diameter in the support thread, and as a threaded connection in the BP thread (general view of the stated screw is shown in FIG. 6), but at its application the design is not strong enough, because the upper part of the screw becomes loosened.

The best results are achieved when the stem is stepped, in which only the lower part from the beginning of the support thread up to the thread on the stem is subjected to boring with a decrease in diameter, and the upper part from the head to the support thread of the abutment remains unchanged and is fixed by the walls of the abutment (FIG. 8). The screw will have an upper stem with a larger diameter and lower screw stem with a smaller rod diameter.

The screw will thus be characterized by the distance from the screw head before the start of the bore—the pitch of the screw thread (SSH), which can vary along the axial height in relation to the screw head, and the ratio of its parameters in relation to the abutment—the distance from the axis of the screw head to the support thread of the abutment, which is named the abutment thread height (ATN), and which determines the tightness between the abutment and the BP.

The technical result with regard to the dental implant containing the base part, the abutment and the connecting screw is that it includes the above-described connecting screw with a step stem, in which the distance from the screw head to the beginning of the lower part—the screw thread pitch (SSH) is less than the distance along the axis from the screw head to the abutment thread (ATN) by 0.1-1 mm. The best results were observed at a difference of 0.2-0.3 mm.

FIGS. 9 and 10 show correct use of a combination of abutment screws inside the implant. The abutments and the implant have an appropriate implant-abutment-bond for connection to each other.

FIGS. 11 and 12 show that if this condition is not met, a poor connection of the elements occurs, as a result of which a short screw inside the abutment for a large height of the gum cannot reach the implantation thread, and a screw with a longer pin pitch inside the abutment for a short height of the gum will not pass through the supporting thread, as a result of which it will not reach the implant thread.

In such compositions it is necessary either to reduce the distance between the screw thread and the screw pitch (SSS) by increasing the gum height and, accordingly, increase the length of the screw or it is necessary to increase the ATN so that the longer screws work together with the selected abutments.

In case of the right ratio of ATN and SSH the selected abutments can be used together with screws with approximately the same nominal diameter of the thread, but with different lengths, which helps to prevent failures when treating the patients.

One of the problems solved in the framework of dental prosthetics is a set of elements of the implant, which helps the doctor to design the implant and to choose a combination of elements that provides reliable BP-abutment connection during the operation.

In this regard, a implantation kit is proposed (RU 2 602 678, 2015), which is the closest analogue for the claimed kit, in which the abutment is provided with auxiliary elements, in particular, a screw, which length and location of the thread on it are calculated in such a way that the abutment screw cannot be engaged with the threaded portion in the implant while the abutment of the end surface of its cam on the cervical end is not placed on the implant platform, the gingiva liner, which is made in such a way, that in the inserted position it does not touch the conical surface of the implant and has a contact surface through which it is adjacent to the end face of the implant, additional abutment and molding element.

Disadvantage of this kit is inability to vary its components depending on characteristics of the surgery for a particular patient.

The technical result with respect to kit invention is to include in the kit—along with the abutment as a part of the additional elements—of the kit of connecting screws having the above described step pin, with a different distance from the screw head to the bore zone of the pin corresponding to the requirements for the abutment in case of low, medium and high gingivas of the patient. Use of such kit helps to reduce the surgery time, to increase the reliability of the implant attachment, to simplify the technology of industrial production of dental implants.

### BRIEF DESCRIPTION OF THE DRAWINGS

The technical character of the claimed group of inventions is illustrated by the following drawings. In all the figures in the drawings, the same elements have the same positions. The following symbols are used:
1—the base part of the dental implant; 2—abutment; 22—support thread;
3—screw; 33—thread; 333—screw stem; 3333—screw head.
GH—gingiva height; ATN—distance from screw head to the threads of the abutment vertically; SSH—vertical length of the screw pitch; SSS—reduction of the diameter of the screw stem.

The list of drawings includes.

FIG. 1. Dental implant with short gingiva height

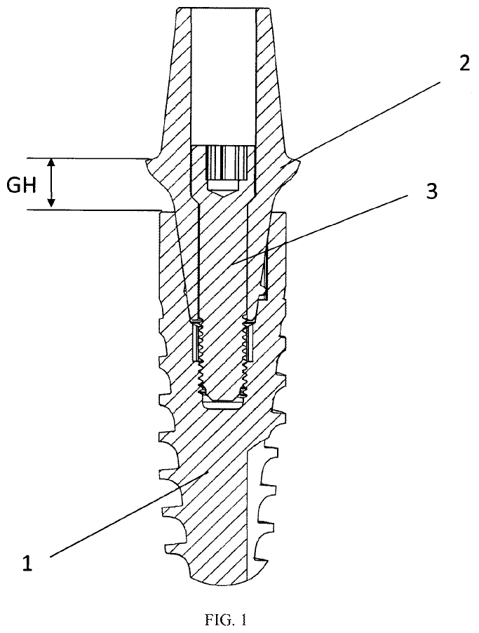

FIG. 2. Dental implant with high gingiva height

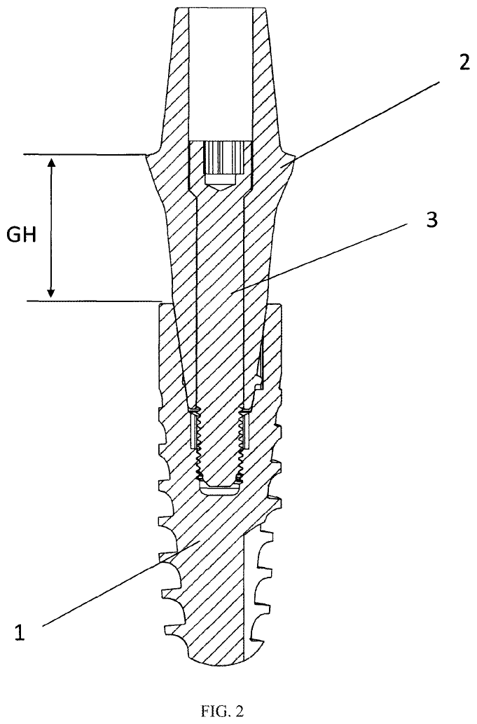

FIG. 3. Negative type—short screw inside of the abutment-implant combination with high gingiva height

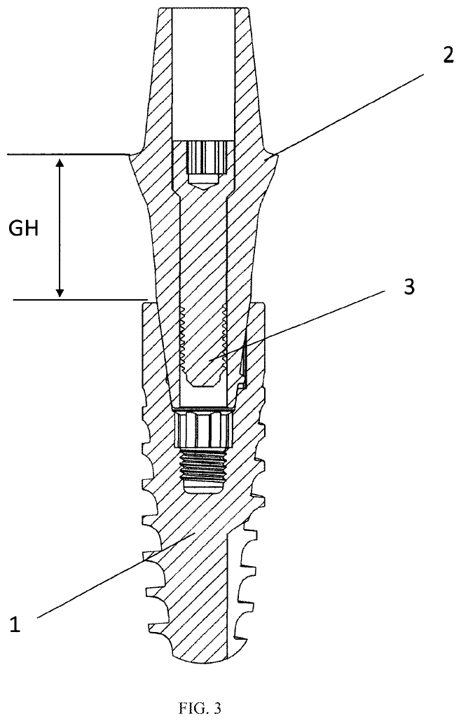

FIG. 4. Negative type—long screw inside of the of the abutment-implant combination in short gingiva height

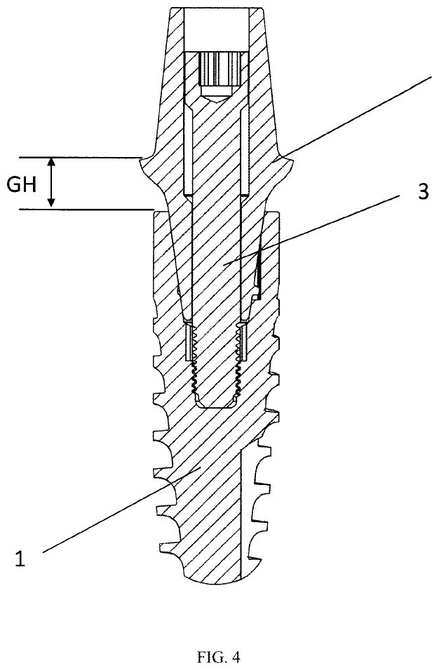

FIG. 5. Screw with large screw stem diameter

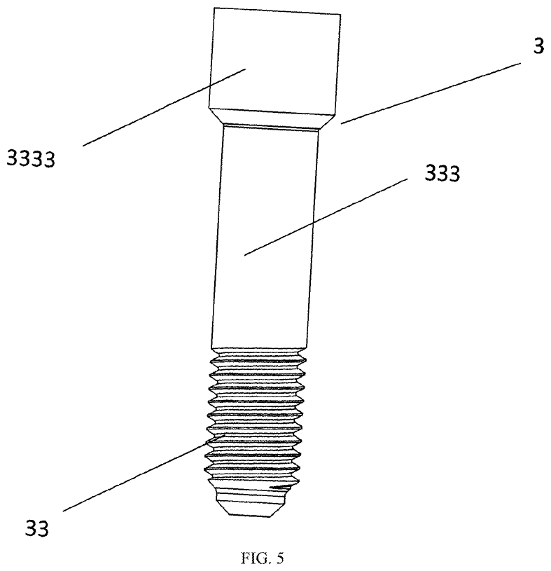

FIG. 6. Screw with a reduced screw stem diameter

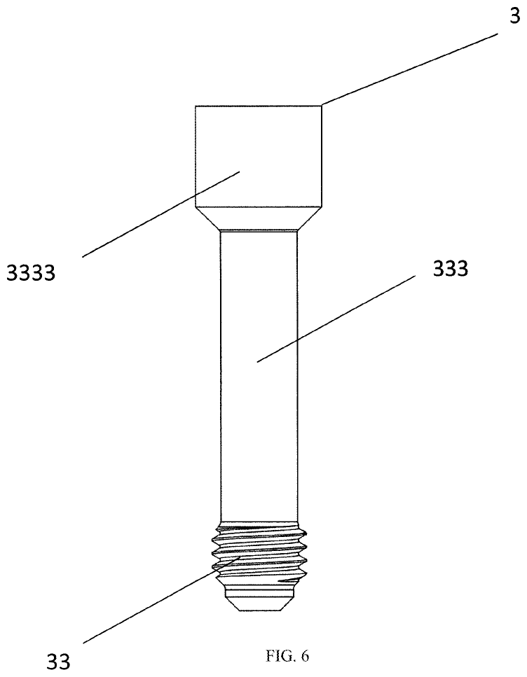

FIG. 7. Abutment with support thread and screw

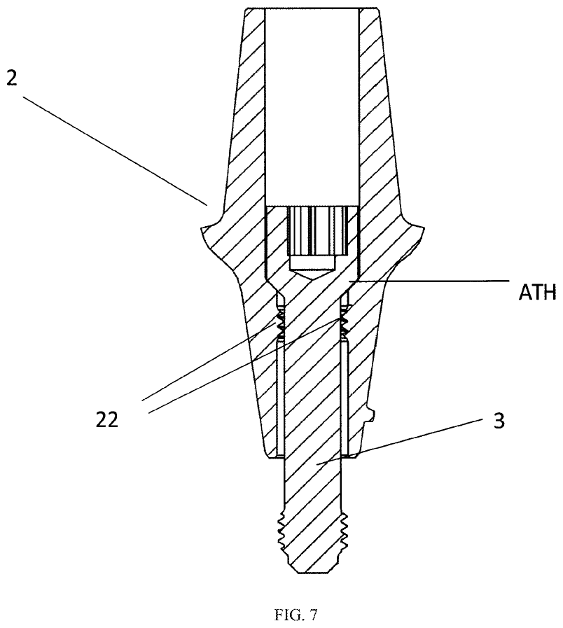

FIG. 8. Screw with screw thread diameter shift

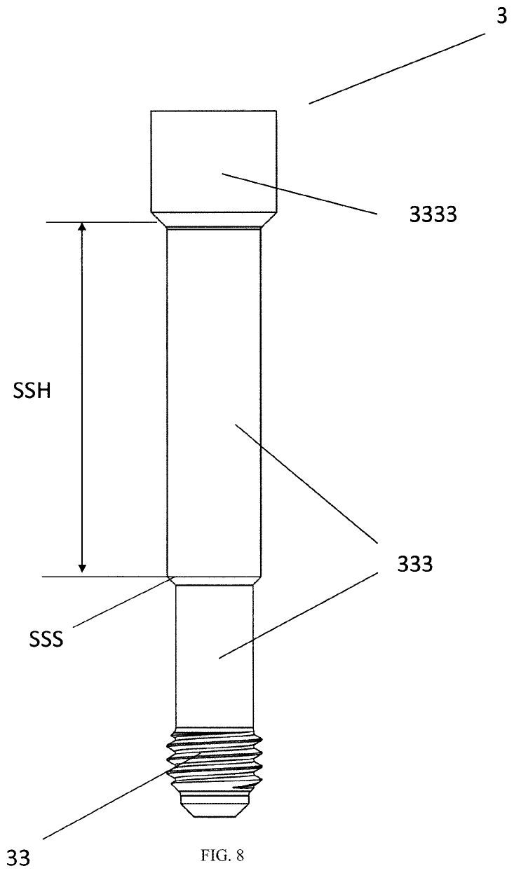

FIG. 9. Dental implant with a screw combination that corresponds to the short gingiva height.

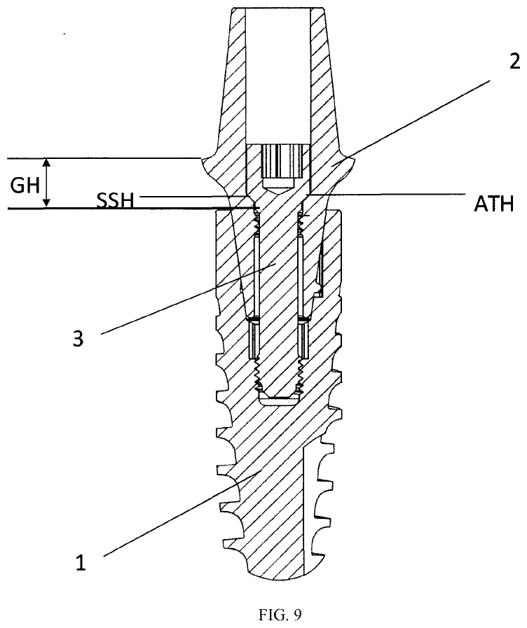

FIG. 10. Dental implant with a screw combination that corresponds to high gingiva height.

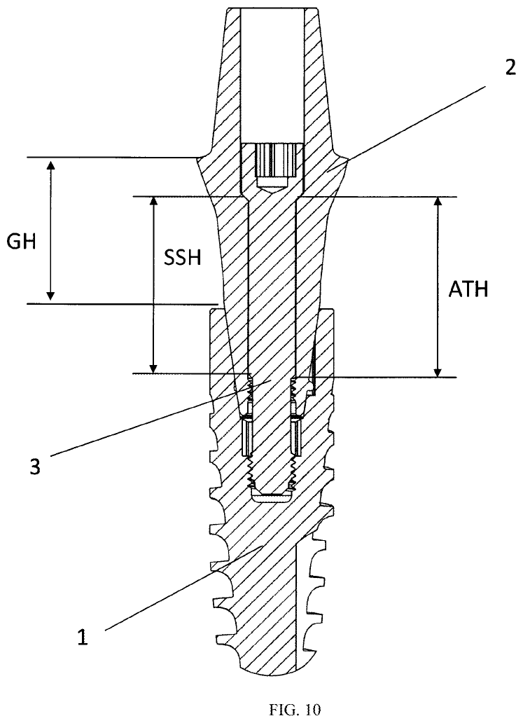

FIG. 11. Negative type: dental implant with a screw combination that does not coincide with the short gingiva height.

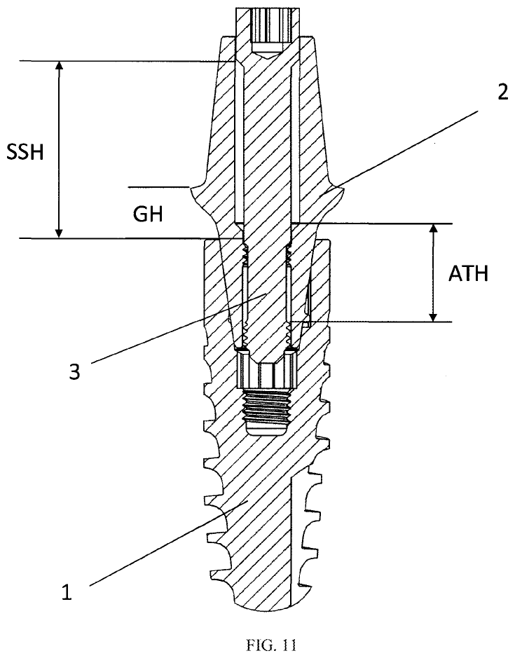

FIG. 12. Negative type: dental implant with a screw combination that does not coincide with the high gingiva height.

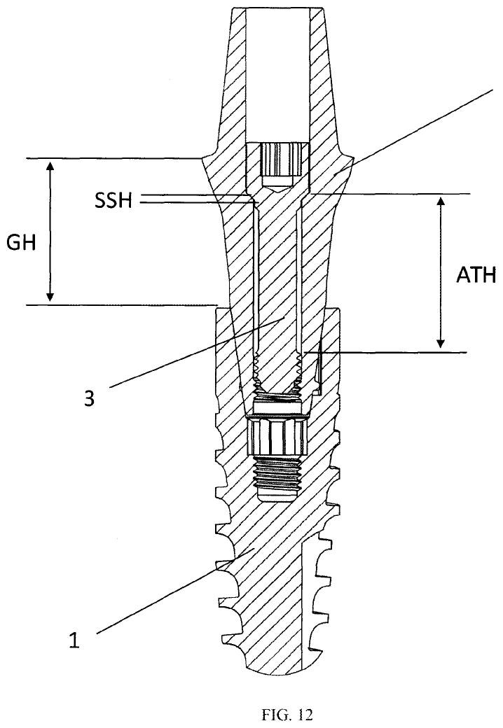

### INDUSTRIAL APPLICABILITY

The prosthesis should be placed as follows. Determine the height of the patient's gingiva and select the appropriate abutment 2. In the patient's mouth, at the first stage of treatment place the basic part 1 in the jaw bone, the basic part 1 has a thread on the outer side, so that placement in the jaw bone can be carried out by screwing into the hole. The thread pitch can be made uniform or variable, and due to appropriate selection of parameters various possible biological factors, etc., as well as different implantation type can also be taken into account. In this case, the design and parameters of the thread are calculated, in particular, taking into account the desirable high primary stability and uniform transfer of forces arising from the masticatory load of the dental implant on the jaw bone. Properly formed cone provides self-braking connection when abutment 2 is inserted into BP 1, providing additional stability of the connection.

After placement of the basic part 1 to the jaw bone, there is a phase of implantation from four weeks up to six months, during which the basic part must grow into the tissue and the jaw bone. Then, at the second stage of treatment, an abutment 2 with the placed denture element can be inserted. In case of particularly favorable bone behavior and correspondingly high primary stability, abutment 2 and other prosthetic components can be placed even immediately after the placement of the base part of the implant. In order to place using a simple method of mechanically relatively stable connection between the base part 1 and the abutment 2, a contact pin is made on the abutment, which at assembly of the base part 1 with the abutment 2 is placed in the shaped recess in the base part. The mechanical connection of the base part 1 to the abutment 2 is carried out by means of a connecting screw 3, the stem 333 is inserted into the abutment by screwing through the support thread 22, lowered to the BP 1, after which the thread of the connecting screw 33 is screwed into the internal thread of the base part 2. In this case, the head of 3333 connecting screw 3 presses the abutment 2 to the base part 1.

Both the base part of the implant and the abutment are usually made of metal or ceramics, in particular titanium, zirconium, titanium alloy, zirconium alloy, titanium-containing alloy, zirconium-containing alloy, ceramics of zirconium oxides and aluminum. In addition, ceramics based on silicon or silicon oxide and containing, for example, carbon or tungsten can be used.

Use of the claimed invention can improve the quality of prosthetics, reduce its complexity.

What is claimed is:

1. A dental implant for placement in a jaw bone, comprising a base part, a abutment and a connecting screw, in which a coronal end of the base part of the implant has a receiving hole for the abutment, having in a direction from the coronal end a conical index portion forming a guide surface for the abutment, and in a cervical direction there is a threaded portion directly adjacent to the index portion for placement of the connecting screw; the abutment contains a connecting zone for connection with the base part of the implant, having the conical portion, to which the index area is adjacent in the cervical direction designed in a way, that it forms a guide surface for a surface of the index portion of the base part of the implant when the abutment is placed in the implant, and at the cervical end it has an end surface with a hole through which the threaded portion of the connecting screw with a supporting thread can be introduced, as well as a connecting screw, comprising of a head and a stein, threaded in a lower part, characterized in that the connecting screw stein is made stepped, and its lower part starting from the support thread to the stein thread has a diameter not exceeding an inner diameter of the support thread of the abutment, and a distance from the screw head to a beginning of the lower part of the stein is less, than a distance along an axis from the screw head to the abutment support thread by 0.1-1 mm.

2. The dental implant according to claim 1, characterized in that the distance from the screw head to the beginning of the lower part of the stein is less than the axis distance from the screw head to the abutment support thread by 0.2-0.3 mm.

3. The connecting screw for the dental implant according to claim 1, connecting the abutment to the base part and consisting of a head and a pin with a thread at its lower end, characterized in that a diameter of the pin is less than the inner diameter of the abutment support thread.

4. The connecting screw according to claim 3, characterized in that it is made stepped so that the area of the stein with a reduced diameter is an area from the stein thread to a top of the abutment support thread.

5. A kit for implantation of the dental implant according to claim 1, comprising the base part of the implant, the abutment, the connecting screw and other auxiliary components, characterized in that it contains a set of connecting screws according to claim 3 with a pitch of the screw corresponding to dimensions of the abutment for implantation of prosthesis in patients with high, medium and low gingiva height.
